(19) United States
(12) Patent Application Publication
(10) Pub. No.: US 2014/0225418 A1
(43) Pub. Date: Aug. 14, 2014

(54) PICK TOOL ASSEMBLY, METHOD FOR MAKING SAME AND METHOD FOR REFURBISHING SAME

(71) Applicant: ELEMENT SIX GMBH, Burghaun (DE)

(72) Inventors: Frank Friedrich Lachmann, Burghaun (DE); Bernd Heinrich Ries, Burghaun (DE)

(21) Appl. No.: 14/345,729

(22) PCT Filed: Sep. 19, 2012
(86) PCT No.: PCT/EP2012/068438

§ 371 Date: Mar. 19, 2014

Related U.S. Application Data
(60) Provisional application No. 61/538,279, filed on Sep. 23, 2011.

(30) Foreign Application Priority Data
Sep. 23, 2011 (GB) 1116414.2

(51) Int. Cl. E21C 35/183; B23P 6/00

(52) U.S. Cl. CPC E21C 35/183; B23P 6/00
USPC 299/104; 29/428; 29/402.08; 404/83

(57) ABSTRACT

A pick tool assembly comprising a working tip, a base and at least one wear protector element. The working tip is attached to the base and the base comprises an attachment member for coupling the base to a driving mechanism. The working tip comprises super-hard material, the base comprises a first material and the wear protector element comprises a second material having greater abrasive wear resistance than the first material. The base and wear protector element are cooperatively configured so that wear protector element is mechanically securable to the base.

This disclosure relates generally to a pick tool assembly, a method for making same and a method for refurbishing same; the pick tool assembly being particularly but not exclusively for road degradation, mining or construction.

U.S. Pat. No. 7,445,294 discloses an attack tool comprising a wear-resistant base suitable for attachment to a driving mechanism, the wear-resistant base comprising a shank and a metal segment. A cemented metal carbide segment is bonded to the metal segment opposite the shank; and at least one hard insert bonded to the metal segment proximate the shank, the insert comprising a hardness greater than 60 HRc.

There is a need for a wear resistant pick tool that is relatively more efficient to manufacture.

Viewed from a first perspective there is provided a pick tool assembly comprising a working tip, a base and at least one wear protector element; the working tip being attached to the base and the base comprising an attachment member for coupling the base to a driving mechanism; the working tip comprising super-hard material, the base comprising a first material and the wear protector element comprising a second material having greater abrasive wear resistance than the first material; the base and wear protector element being cooperatively configured so that wear protector element is mechanically securable to the base.

Viewed from a second perspective there is provided a method of making a pick tool, the method including providing a base comprising a slot configured for accommodating and mechanically securing a wear protector element according to this disclosure, and inserting the wear protector element into the slot to mechanically attach the wear protector element to the base. It will not be necessary to bond the wear protector element to the base by means of braze material, adhesive or other bond material, although bond material may be applied to improve the securement further.

Viewed from a third perspective there is provided a method for refurbishing a base for a pick tool according to this disclosure, the method including providing a used base comprising a used first wear protector element mechanically secured within a slot formed in the base; extracting the first wear protector element from the slot; providing a second wear protector element and inserting the wear protector element into the slot and mechanically attaching the second wear protector element to the base. The first wear protector element may be in a substantially worn condition and the second wear protector element may be substantially unworn or in a completely unworn condition (i.e. not previously used).

Various arrangements and combinations of aspects of pick tool assemblies, bases for pick tools and wear protector elements are envisaged by this disclosure, non-limiting and non-exhaustive examples of which are set out below.

The pick tool assembly may be for road planing and the working tip may comprise polycrystalline diamond (PCD) material, silicon-carbide bonded diamond material or other diamond-containing material, or polycrystalline cubic boron nitride (PCBN) material. The working tip may comprise a super-hard structure joined to a cemented carbide substrate. The substrate may be attached to a support structure comprising cemented carbide material, which may comprise a shaft that is shrink fit into a bore formed within the base. The second material will have substantially greater abrasive wear resistance than the first material, and the second material may be substantially harder than the first material, which may have hardness of at most about 60 HRc. In some arrangements, the base may comprise steel and the wear protector element may comprise cemented carbide material, and or the base may comprise cemented carbide material and the wear protector element may comprise super-hard material.

Example wear protector elements may be inserts, rivets, pins or studs, and may comprise a stem for insertion into a slot provided in base.

Various example mechanisms for attaching the wear protector element to the base are envisaged. The base may be provided with a slot for accommodating and mechanically attaching the wear protector element, for example by means of interference fit, clamp or inter-engagement mechanism.

In some example arrangements, an external surface of the base may include at least one slot, configured operative to attach mechanically the wear protector element to the base. In some arrangements the wear protector element and or the slot may be provided with one or more securement structures for enhancing securement, or the wear protector element and or the slot may be substantially free of structures for enhancing securement. In some example arrangements, the securement structures may comprise a plurality of projections, troughs, ridges, serrations or corrugations. In some arrangements, the wear protector element may have opposite ends connected by a side surface having a plurality of elongate ridges, serrations or corrugations extending axially between the ends, and or arranged circumferentially on the side surface. The securement structures may be configured to provide a mechanical inter-engagement mechanism between the wear protector element and the slot. In some arrangements the wear protector element may be attached to the base by means of a flange or a tongue and groove mechanism. A slot provided with a flange or groove may be formed in the base and the wear protector element may be configured to be capable of sliding into the slot and prevented from becoming detached at least by the flange or groove.

In some arrangements, the wear protector element and a slot formed into the base may be configured to reduce point loading at edges and corners when the wear protector element is inserted into the slot as in use. For example, there may be a re-entrant gap between the wear protector element and the slot at an edge and or corner of at least one of them. In some examples, the wear protector element may comprise a stem for insertion into a slot within the base, the stem having a distal end comprising rounded, chamfered or bevelled peripheral edge to provide a gap between the edge and an adjacent corresponding corner of the slot, and or the outer peripheral edge of the slot may be rounded, chamfered or bevelled.

Disclosed pick tool assembly arrangements and methods for making or refurbishing pick tools may have the aspect of enhanced ease and efficiency of manufacture since it is not necessary to apply a bond material. This is likely to make it much easier to replace wear protector elements in the field without special equipment. Furthermore, since brazing the wear protector elements onto the base would require the base to be heated, which may result in some thermal degradation of the pick including a PCD tip, the disclosure may provide a method that reduces thermal degradation of the pick during manufacture.

Example arrangements will now be described with reference to the accompanying drawings, of which:

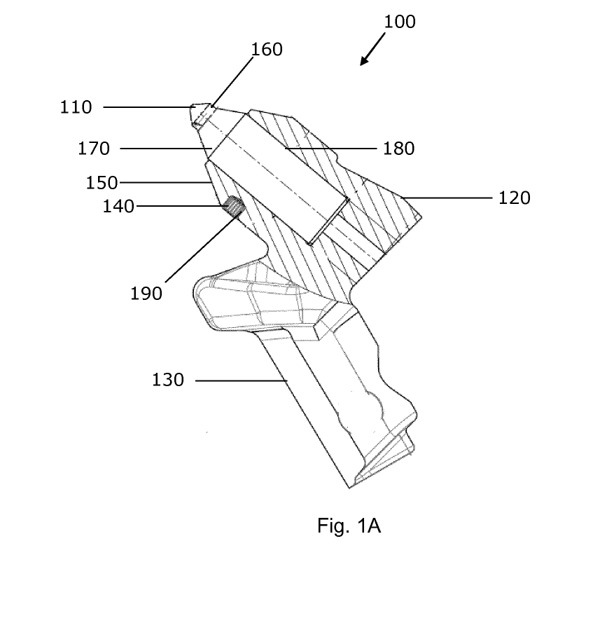

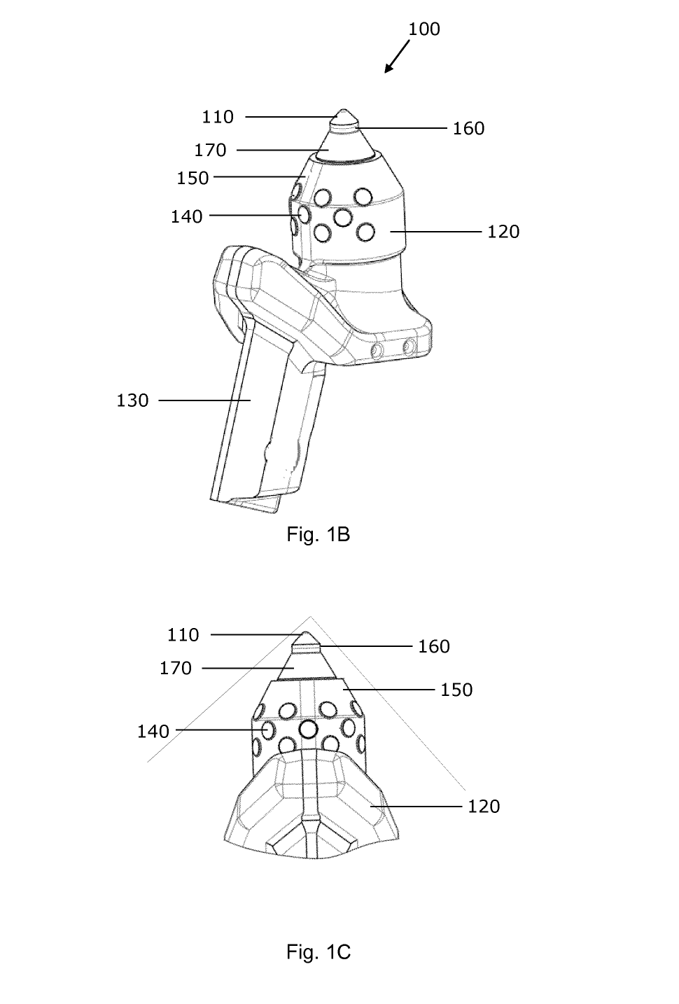

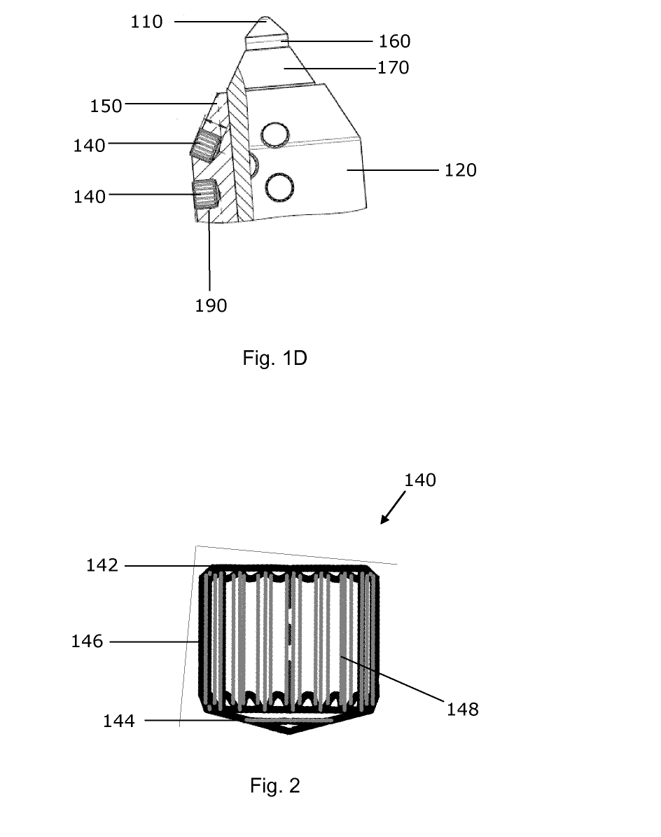

FIG. 1A shows a partly cut-away side view of an example pick tool for road planing;

FIG. 1B shows a perspective view of the example pick tool shown in FIG. 1A;

FIG. 1C shows a different perspective view of part of the example pick tool;

FIG. 1D shows a partly cut-away side view of a part of the example pick tool;

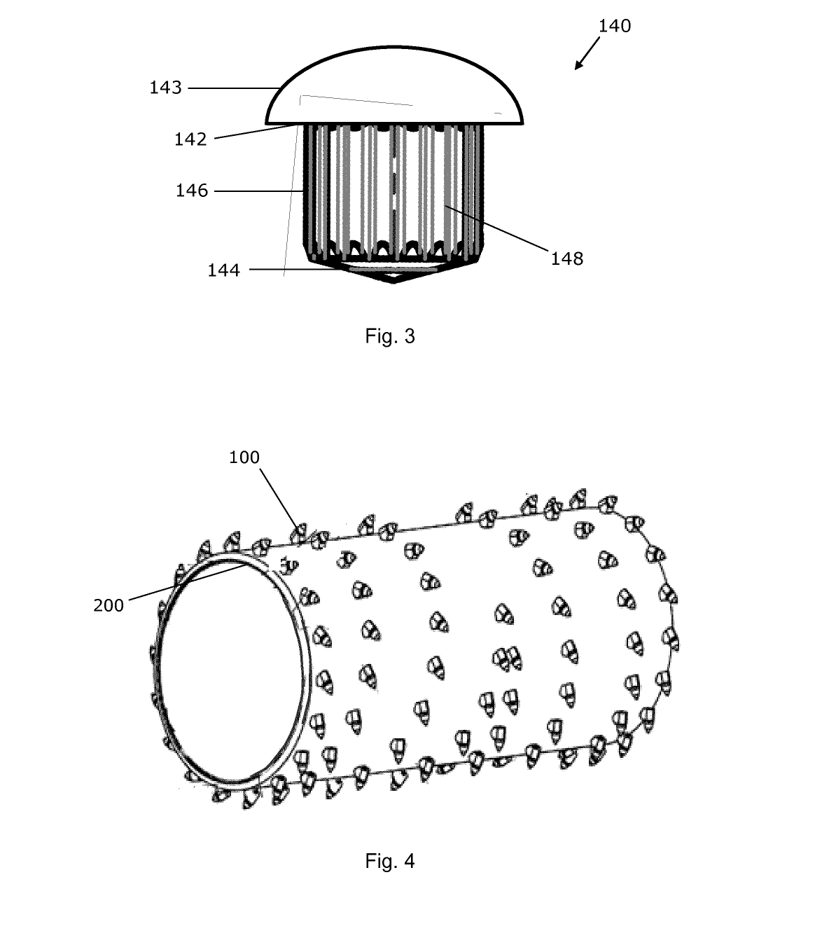

FIG. 2 and FIG. 3 show drawings of example wear protector elements; and

FIG. 4 shows a schematic drawing of a drum for a road planing vehicle.

With reference to FIG. 1A, FIG. 1B, FIG. 10 and FIG. 1D an example arrangement of an assembled pick tool assembly 100 for road planing comprises a working tip 110 attached to a steel base 120 comprising a shank 130 as the attachment member for coupling the base 120 to a driving mechanism such as a drum (not shown), and a plurality of cemented carbide wear protector insert elements 140 press fit into respective slots 190 attached to an external forward-facing surface 150 of the base 120. In this context, “forward facing” refers to the part of the pick 100 facing the direction of movement of the pick 100 when in use. The working tip 110 comprises a rounded conical PCD structure joined to a cemented tungsten carbide substrate 160, which is brazed to a cemented carbide support structure 170 generally in the form of columnar shaft that is shrink fit into a bore 180 formed within the base 120. The base 120 comprises steel and the wear protector elements 140 comprise cemented carbide.

In manufacture, the base 120 is provided with the slots 190 for the wear protector elements 140, which may each be press fit into respective slots 190 by knocking them in with a hammer, for example. This relatively simple and fast process is likely to result in substantially improvement in manufacturing efficiency.

Example wear protector elements 140 are illustrated in FIG. 2 and FIG. 3 and comprise a pin portion 146 having proximate end 142 and a distal end 144. In use, the proximate end 142 will be exposed to potentially abrasive wear conditions and the distal end 144 will be inserted into a slot in the base of a pick tool. The side of the pin portion 146 comprises a corrugation 148 (i.e. a series of alternating ridges and troughs) extending axially from one end to the other. The corrugation (or serration) 148 may enhance the securement of the wear protector element 140 when it is press fit into the slot of the base as in use. The example wear protector element shown in FIG. 3 comprises a cap 143 at the proximate end 42, which may provide enhanced protection for the base against wear in use.

With reference to FIG. 4, a plurality of pick tools 100 for use in road planing may be connected to a drum 200 for a road planing vehicle (not shown). Each pick 100 may be coupled to a respective base block welded to the drum 200 by inserting the attachment member of the pick 100 into a bore within the base block. As the drum 200 is rotated clockwise in the figure, the pick tools 100 are driven in a forward direction, i.e. such that the super-hard tips are the foremost members of the respective picks. The drum 200 is positioned at a sufficient height above a road surface such that the tips can engage and break up the road structure to the desired depth as the drum 200 is rotated with sufficient force by the driving vehicle. Road material will brush against the base of the picks 100 and will tend to abrade them, resulting in the removal of material from the bases of the picks 100 and the picks 100 will ultimately need to be replaced as a result. The wear protector elements attached to the base, particularly at the forward facing part of the base, will tend to retard this wear process and will likely extend the working life of the pick.

The pick tool may be for drill bits, percussion drill bits, roller cone bits, shear bits, milling machines, indenters, mining picks, asphalt picks, cone crushers, vertical impact mills, hammer mills, jaw crushers, asphalt bits, chisels, trenching machines, for example.

Certain terms as used herein are briefly explained below.

A pick tool is a degradation tool for degrading or breaking up hard bodies or formations, such as roads or rock formations. For example, a pick for road planing may be capable of being used for breaking up asphalt or concrete road or pavement formations. A pick for mining may be capable of being used for breaking up a rock formation for recovering coal or potash in a mining application. Picks of various kinds may be used for boring into the earth to construct tunnels or drill bore holes, for example.

As used herein, “super-hard” means a Vickers hardness of at least 25 GPa. Synthetic and natural diamond, polycrystalline diamond (PCD), cubic boron nitride (cBN) and polycrystalline cBN (PCBN) material are examples of superhard materials. Synthetic diamond, which is also called man-made diamond, is diamond material that has been manufactured. As used herein, PCBN material comprises grains of cubic boron nitride (cBN) dispersed within a matrix comprising metal and or ceramic material. PCD material comprises a mass (an aggregation of a plurality) of diamond grains, a substantial portion of which are directly inter-bonded with each other and in which the content of diamond is at least about 80 volume percent of the material. Interstices between the diamond grains may be at least partly filled with a binder material comprising a catalyst material for synthetic diamond, or they may be substantially empty. Catalyst material for synthetic diamond is capable of promoting the growth of synthetic diamond grains and or the direct inter-growth of synthetic or natural diamond grains at a temperature and pressure at which synthetic or natural diamond is thermodynamically more stable than graphite. Examples of catalyst materials for diamond are Fe, Ni, Co and Mn, and certain alloys including these. Bodies comprising PCD material may comprise at least a region from which catalyst material has been removed from the interstices, leaving interstitial voids between the diamond grains.

Other examples of super-hard materials include certain composite materials comprising diamond or cBN grains held together by a matrix comprising ceramic material, such as silicon carbide (SiC), or cemented carbide material, such as Co-bonded WC material (for example, as described in U.S. Pat. Nos. 5,453,105 or 6,919,040). For example, certain SiC-bonded diamond materials may comprise at least about 30 volume percent diamond grains dispersed in a SiC matrix (which may contain a minor amount of Si in a form other than SiC). Examples of SiC-bonded diamond materials are described in U.S. Pat. Nos. 7,008,672; 6,709,747; 6,179,886; 6,447,852; and International Application publication number WO2009/013713).

1. A pick tool assembly comprising
a working tip
comprising super-hard material and attached to
a base comprising
a first material and
an attachment member for coupling the base to a driving mechanism; and a wear protector element comprising
a second material having greater abrasive wear resistance than the first material;
the base and wear protector element being cooperatively configured so that wear protector element is mechanically securable to the base, which is provided with a slot for accommodating and mechanically securing the wear protector element, and the wear protector element provided with at least one securement structure for enhancing securement to the base by means of an interference fit;
in which the securement structure
is configured to provide a mechanical inter-engagement mechanism between the wear protector element and the slot, and
comprises a plurality of projections, troughs, ridges, serrations or corrugations extending axially between opposite ends of the wear protector element and arranged circumferentially on the side surface.

2. A pick tool assembly as claimed in claim 1, suitable for road planning or mining.

3. A pick tool assembly as claimed in claim 1, in which the working tip comprises PCD material.

4. A pick tool assembly as claimed in any one of the preceding claims, in which the base is provided with a slot for accommodating and mechanically securing the wear protector element.

5. A pick tool assembly as claimed in any one of the preceding claims, in which the wear protector element is securable to the base by means of an interference fit.

6. A pick tool assembly as claimed in any one of the preceding claims, in which the wear protector element is securable to the base by means of a clamp or inter-engagement mechanism.

7. A pick tool assembly as claimed in any one of the preceding claims, in which the wear protector element is provided with a securement structure for enhancing securement to the base.

8. A pick tool assembly as claimed in any one of the preceding claims, in which the wear protector element is provided with a plurality of projection, trough, ridge, serration or corrugation structures for enhancing securement to the base.

9. A pick tool assembly as claimed in claim 8, in which the projection, trough, ridge, serration or corrugation structures extend axially between opposite ends of the wear protector element.

10. A pick tool assembly as claimed in any one of the preceding claims, in which the wear protector element is securable to the base by means of a flange mechanism.

11. A pick tool assembly as claimed in any one of the preceding claims, in which the wear protector element is securable to the base by means of a tongue and groove mechanism.

12. A pick tool assembly as claimed in claim 1, in which the base comprises steel and the wear protector element comprises cemented carbide material.

13. A pick tool assembly as claimed in claim 1, in which the base comprises cemented carbide material and the wear protector element comprises super-hard material.

14. A method of making a pick tool assembly as claimed in any one of the preceding claims, the method including providing a base comprising a slot configured to accommodate and mechanically secure a wear protector element, and inserting the wear protector element into the slot.

15. A method for refurbishing a base for a pick tool assembly as claimed in claim 1, the method including providing a used base comprising a used first wear protector element mechanically secured within a slot formed in the base; extracting the first wear protector element from the slot; providing a second wear protector element and inserting the wear protector element into the slot and mechanically attaching the second wear protector element to the base.
